(19) United States
(12) Patent Application Publication
(10) Pub. No.: US 2007/0089677 A1
(43) Pub. Date: Apr. 26, 2007

(54) Milking apparatus and method for use thereof

(76) Inventor: Shimshon Sagiv, Moshav Ramat Magshimim (IL)

Correspondence Address: NIXON & VANDERHYE, PC, 901 NORTH GLEBE ROAD, 11TH FLOOR, ARLINGTON, VA, 22203, US

(21) Appl. No.: 10/577,945

(22) PCT Filed:
(86) PCT No.: PCT/IL03/00936

(51) Int. Cl. A01J 3/00

(52) U.S. Cl. 119/14.02

(57) ABSTRACT

An apparatus for gripping the teat of an animal assisting in drawing milk therefrom. The apparatus includes a housing and more than one constricting element arranged in the housing so that the constricting elements, which are operable in both constricting and non-constricting modes, periodically constrict the teat. The apparatus further includes means for switching the constricting elements back and forth between non-constricting and constricting modes. The apparatus includes a controller in communication with the means for switching, which in accordance with a predetermined timing and spatial sequence controls the periodic switching of the constricting elements from constricting to non-constricting modes and vice-versa. A system including such a gripping apparatus for drawing milk from the teat of an animal is also taught. Similarly, a method for milking an animal which imitates hand milking and does not employ a vacuum system is described.

### FIELD OF THE INVENTION

The present invention relates to an apparatus, system and method for milking ruminants.

### BACKGROUND OF THE INVENTION

Milking machines, as currently constructed, are intended to reproduce the physical effect of a young mammal suckling at its mother's teat. A young mammal forms a closure at the base of its mother's teat producing a sub-atmospheric pressure in the youngster's mouth. The difference in pressure between that in the young mammal's mouth and that in the milk duct in the mother's teat forces the sphincter of the teat to open resulting in a flow of milk.

Modern milking machines are intended to reproduce the effect of a suckling animal generally by using vacuum producing machines. The vacuum generating apparatus is connected to a teat cup which fits onto a lactating animal's teat. The teat cup is subjected to variable pressures from atmospheric to sub-atmospheric, thereby periodically opening the sphincter of the teat causing milk to flow therefrom.

More specifically, conventional automatic milking machines use teat cup assemblies which mimic the suction employed by a suckling mammal. A typical teat cup assembly includes a hollow rigid outer shell or cup attached to a pulsating vacuum line and an elongated flexible resilient tubular inflation, also called a “liner”, which fits inside the outer shell and is connected to a constant vacuum source. Since the shell is attached to a pulsating vacuum line, the pressure in the outside annular chamber formed by the shell and the tubular inflation alternates between atmospheric and sub-atmospheric pressures. The constant vacuum applied to the tubular inflation draws milk from the animal's teat. At the same time, the alternating pressure in the outside annular chamber causes periodic inward collapse of the wall of the tubular inflation. This collapse results in a massaging action on the teat.

Prior to the advent of milking machines, hand milking was, for millennia, the method for extracting milk from the udder of a lactating ruminant. In hand milking, when the teat is full of milk, the milker's hand closes off the teat from the udder, generally at or near the teat-udder junction, using the thumb and forefinger as indicated in FIG. 1A. This renders impossible the return of milk from the teat to the udder. As shown in FIG. 1B, the milker then closes his remaining fingers around the teat until they all squeeze the teat as in FIG. 1C. This closure is effected in stages from the top to the bottom of the teat thus squeezing the milk content from top to bottom and then out of the teat. After the teat is emptied, the hand is relaxed and the teat refills with milk arriving from the udder. The milking cycle is then repeated.

Milking apparatuses employing vacuum methods generate problems. The use of vacuum methods often causes bleeding in, inflammation of, and infection in the teat. The use of vacuum methods also can cause damage to the teat's sphincter. Using the vacuum method allows an undesirable reverse flow of milk from the teat to the udder when the pressure returns to atmospheric pressure causing pain in the animal's udder. In addition, the cost of a vacuum milking apparatus is high. For these and other reasons, it would be advantageous to develop a reliable alternative to vacuum-based milking systems.

### TERMINOLOGY

The words “constricting”, “constrict”, “constricted”, “constricting element” and the like, when used herein above and below, also include the concept of compression. Similarly, the listed terms and the like are meant to include both partial and total constriction and/or compression. There is no attempt at distinguishing between the use of “constriction” and “compression” or other similar derivative words.

The words “animal”, “mammal” and “ruminant” are being used herein above and below interchangeably without any attempt at connoting a distinction. They all refer to the same thing: a living organism providing milk, i.e. a mammal, typically a domesticated ruminant.

### SUMMARY OF THE PRESENT INVENTION

It is an object of the present invention to provide an apparatus, system, and method for milking lactating ruminants, which will result in fewer harmful physiological side effects to the lactating animals.

It is a further object of the invention to provide an apparatus, system, and method for milking which will increase the rate of milking and the amount of milk obtained from a milking.

It is a further object to provide a cheaper milking apparatus than the vacuum-based apparatuses currently being used in diary installations.

According to one aspect of the present invention, there is provided an apparatus for gripping the teat of an animal and assisting in drawing milk from the animal via a compressible milk collector. The apparatus includes a housing and more than one constricting element arranged in the housing. The constricting elements are in touching relation to the milk collector and they are selectably operable in constricting and non-constricting modes. The apparatus also includes means for selectably switching the constricting elements back and forth between their non-constricting and constricting modes. The apparatus further includes a controller in communication with the means for selectably switching. The controller is operative to effect a predetermined timing and sequence for periodically switching the constricting elements between their constricting and non-constricting modes, thereby compressing the teat of the animal and drawing milk therefrom.

In one embodiment, the constricting elements may be pneumatically inflatable sack-like elements, and the means for selectably switching may be a pneumatic means, such as an air compressor, and pneumatic air valves operated by the controller.

In another embodiment, the constricting elements may be pairs of complementary displaceable rings. Each of the pairs of complementary displaceable rings includes a first and second ring, each ring being asymmetrically positioned around a milk collector into which a teat has been inserted. When activated the second ring of a pair of complementary rings is displaced in a direction opposite to the direction of displacement of the first ring of the pair, thereby compressing the teat. When the constricting elements are complementary displaceable rings, the means for selectably switching may be a cam-based mechanical switching system.

In some embodiments the housing may be cylindrically-shaped.

In another aspect of the present invention there is provided a system for milking an animal. The system includes at least one apparatus for gripping the teat of an animal, assisting in drawing milk from the animal via a compressible milk collector. The apparatus includes a housing and more than one constricting element arranged in the housing in touching relation to the milk collector. The constricting elements are selectably operable in constricting and non-constricting modes. The apparatus further includes means for selectably switching the constricting elements back and forth between their non-constricting and constricting modes. The apparatus also includes a controller in communication with the means for selectably switching. The controller is operative to effect a predetermined timing and sequence for periodically switching the constricting elements between their constricting and non-constricting modes. The system also includes a milking claw in flow communication with the milk collector and which collects milk accumulated within the milk collector. The claw has a vent to maintain atmospheric pressure on the teat. Also present is a suction generating means that draws milk from the claw, and a collection vessel, in flow communication with the suction generating means, in which milk drawn from the milking claw is collected.

In one embodiment, the constricting elements of the apparatus in the system may be pneumatically inflatable sack-like elements, and the means for selectably switching may be a pneumatic means, such as an air compressor, and pneumatic air valves operated by the controller.

In another embodiment of the system of the present invention, the constricting elements of the apparatus may be pairs of complementary displaceable rings. Each of the pairs of complementary displaceable rings includes a first and second ring, each ring being asymmetrically positioned around a milk collector into which a teat has been inserted. When activated, the second ring of a pair of complementary rings is displaced in a direction opposite to the direction of displacement of the first ring of the pair, thereby compressing the teat. When the constricting elements are complementary displaceable rings, the means for selectably switching may be a cam-based mechanical switching system.

In some embodiments of the system the housing of the apparatus may be cylindrically shaped.

In yet another aspect of the present invention there is provided a method for milking an animal. The method includes the steps of: positioning a teat of the animal in a compressible milk collector; constricting the teat at a point near the udder-teat junction of the animal; constricting the remainder of the teat in a predetermined temporal and spatial sequence; releasing the constricted teat after all milk in the teat has been expressed therefrom, thereby allowing the teat to return to its non-constricted state, the expressed milk flowing into the milk collector; and repeating the steps of constricting and releasing until termination of the milking operation.

In another embodiment of the method, the step of constricting the remainder of the teat includes constricting individual sections of the teat in a predetermined sequence in a direction away from the udder, the individual sections being held constricted until all sections of the teat have been constricted. The predetermined sequence of constricting individual sections may be a linear sequence wherein each section is constricted after its immediately preceding section.

In a further embodiment of the method, the step of releasing includes releasing all sections of the constricted teat simultaneously.

In an embodiment of the method, the step of constricting the remainder of the teat includes constricting individual sections of the teat in a predetermined sequence in a direction away from the udder, each individual section being held constricted only until the next section is constricted, the next section being the adjacent section further away from the udder.

In a further embodiment of the method, the step of releasing includes releasing a constricted section of the teat after the next adjacent section of the teat, in a direction away from the udder, has been constricted. In such an embodiment, the step of releasing further includes releasing the constricted section of the teat furthest from the udder after substantially all the milk in the teat has been expressed.

In another aspect of the present invention there is provided a second method for milking. This second method includes the steps of: positioning a teat of an animal in a compressible milk collector and further positioning the teat and milk collector within a gripper apparatus; activating a portion of the gripper apparatus so that the section of the teat nearest the udder-teat junction of the animal is constricted; activating the remaining portions of the gripper apparatus so that the remaining sections of the teat are constricted in a predetermined temporal and spatial sequence beginning at the portion of the teat closest to the udder and proceeding to the portion of the teat furthest from the udder; releasing the constricted teat after all the milk in the teat has been expressed therefrom, thereby allowing the teat to return to its non-constricted state, the expressed milk flowing into the milk collector; and repeating the steps of activating and releasing until termination of the milking operation.

In an embodiment of this second method, the gripper apparatus may include constricting elements which are individually, and in a predetermined sequence, brought into their constricting mode from their non-constricting mode while proceeding in a direction away from the udder of the animal.

In yet another embodiment of this second method, the step of releasing may include releasing all of the constricting elements of the gripper apparatus simultaneously after all the elements have been activated, thereby returning them all to their non-constricting mode from their constricting mode.

In another embodiment of this second method, the step of positioning may include the step of positioning the junction of the teat and udder near a first constricting element of the gripper apparatus, where the first such element is the element closest to the udder of the animal.

In yet another embodiment of this second method, the gripper apparatus may include constricting elements which are individually, and in a predetermined sequence, brought into their constricting mode from their non-constricting mode while proceeding in a direction away from the udder of the animal, each constricting element being activated after the activation of its preceding adjacent constricting element in the direction toward the udder, while all other preceding constricting elements have been returned to their non-constricting mode. The step of positioning may also include positioning the junction of the teat and udder near a first constricting element of the gripper apparatus, where the first such element is the element closest to the udder of the animal.

In a further aspect of the present invention there is provided an apparatus for gripping the teat of an animal which assists in drawing milk from the animal via a compressible milk collector. The apparatus includes a housing and more than one constricting element arranged in the housing in touching relation to the milk collector. The constricting elements are selectably operable in constricting and non-constricting modes. The apparatus also includes means for selectably switching the constricting elements, back and forth between their non-constricting and constricting modes, thereby compressing the teat of the animal drawing milk therefrom.

In one embodiment of this aspect of the invention the constricting elements are pneumatically inflatable sack-like elements and the means for selectably switching is a pneumatic means, such as an air compressor, and pneumatic air valves.

In another embodiment of this aspect of the invention, the constricting elements are pairs of complementary displaceable rings and the means for selectably switching is a cam-based mechanical switching system. The pairs of complementary displaceable rings each include a first and second ring. Each ring is asymmetrically positioned around a teat inserted into a milk collector. When activated the second ring of a pair of complementary rings is displaced in a direction opposite to the direction of displacement of the first ring of the pair, thereby coinpressing the teat.

### BRIEF DESCRIPTION OF THE DRAWINGS

The present invention will be understood and appreciated more fully from the following detailed description taken in conjunction with the drawings in which:

FIGS. 1A-1C represent the stages of hand milking a ruminant;

FIG. 2A is a schematic representation of a milking system constructed according to an embodiment of the present invention;

FIG. 2B is an enlarged schematic representation of the milking system shown in FIG. 2A;

FIG. 3A shows a cut-away view of an apparatus constructed according to an embodiment of the present invention;

FIGS. 3B-3C show lateral and top views respectively of the apparatus shown in FIG. 3A;

FIGS. 4A-4D are schematic illustrations of an embodiment of the method of the present invention;

FIG. 5 is a graphical representation of the pressure-time inflation sequence used in the method of FIG. 4 when employing the apparatus shown in FIGS. 3A-3C;

FIGS. 6A-6D are different views of an apparatus constructed according to a second embodiment of the present invention;

FIGS. 7A-7H are detailed views of the cam mechanism operative as the switching means in the embodiment shown in FIGS. 6A-6D; and

FIG. 8 is a view of a system constructed according to the embodiment shown in FIGS. 6A-7H.

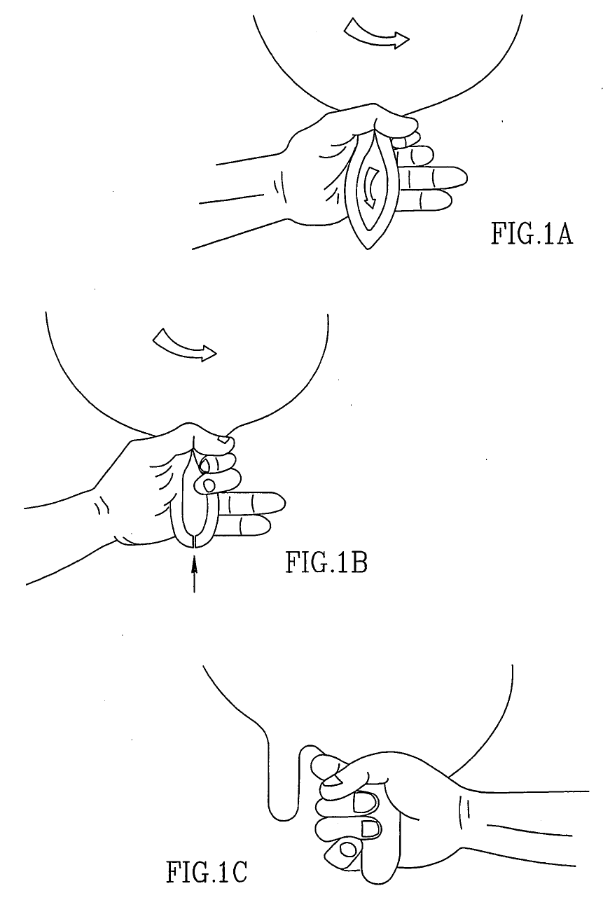

Similar elements in the Figures are numbered with similar reference numerals.

### DETAILED DESCRIPTION OF PREFERRED EMBODIMENTS

The present invention teaches an apparatus (hereinafter also referred to as a “gripper” or “gripper apparatus”), a system, and a method for use in milking ruminants. The apparatus, system and method described herein do not require vacuum systems to produce pressure differentials on a ruminant's teat to deliver milk therefrom. Rather, a. gripper apparatus is used, the apparatus constructed to operate much as the human hand does during a milking operation. The gripper typically is comprised of a plurality of independent constricting elements which tighten around a lactating ruminant's teat in a predefined temporal and spatial sequence. Typically, but without being limiting, after all the constricting elements are tightened around the teat and all the milk in the teat is expressed therefrom, the elements are loosened and a new cycle of sequential tightening is initiated. These cycles continue until the milking operation is terminated.

In one embodiment of the present invention, the independent constricting elements are a plurality of flexible hollow sack-like elements which are cyclically pneumatically inflated and deflated. Typically, inflation begins with the sack closest to the point where the teat meets the udder, herein called the “teat-udder junction”, and then proceeds in the direction away from the udder thereby squeezing out all the milk which is contained in the milk duct of the teat. The sacks are then deflated simultaneously and the cycle of inflation and deflation is repeated. Backflow of milk from the teat to the udder during the milking operation is prevented by the inflation of the sack-like constricting element nearest the udder.

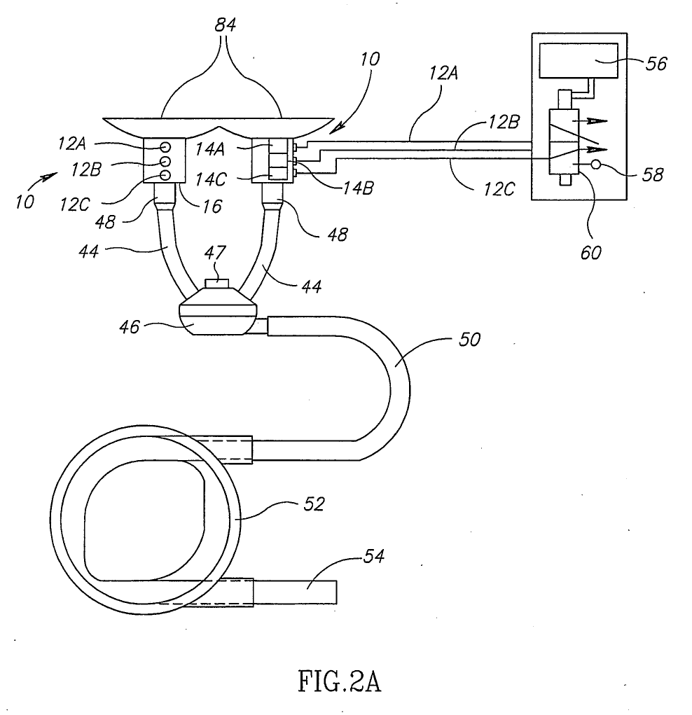

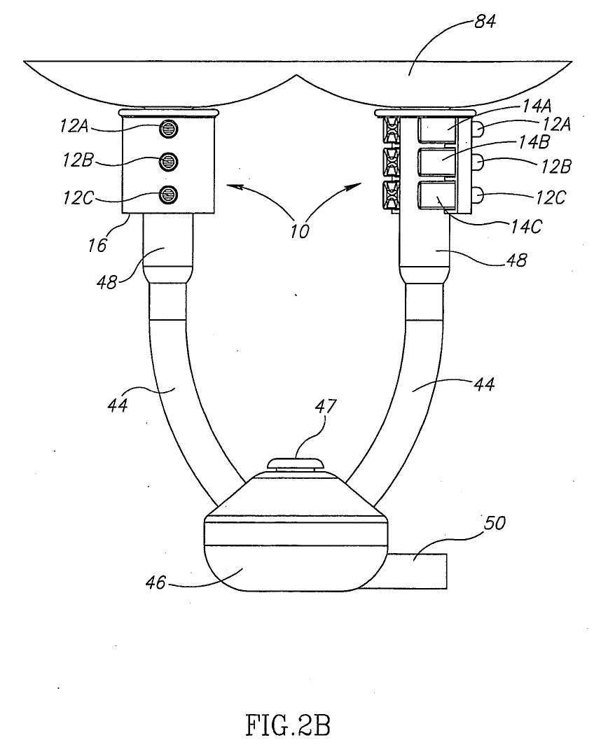

Reference is now made to FIG. 2A which shows a schematic view of a typical milking system for milking ruminants constructed according to an embodiment of the present invention. FIG. 2B is an enlarged truncated view of the system shown in FIG. 2A. Both views are discussed together immediately herein below.

Gripper apparatus 10 surrounds flexible milk collectors 48 into which a teat (not visible) of the ruminant has been inserted. Only the udder 84 of the animal is seen in FIGS. 2A-2B. Milk collector 48 is constructed of a waterproof flexible compressible material. Such materials include, but are not limited to, silicone and rubbers, such as nitrile butadiene rubber (NBR) or Neoprene (polychloroprene) rubber.

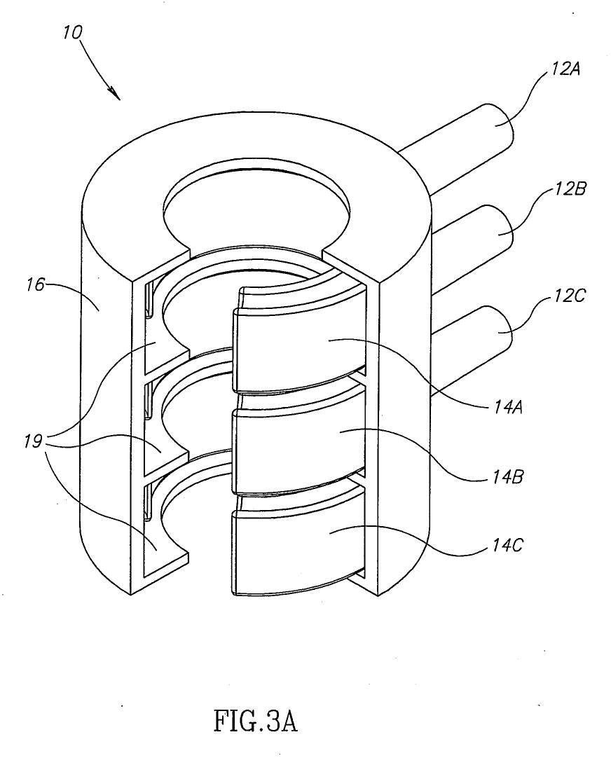

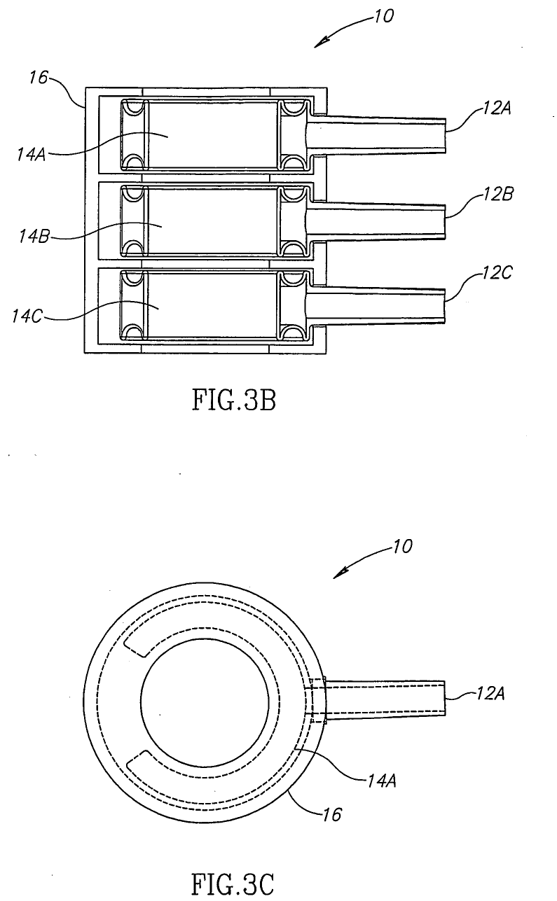

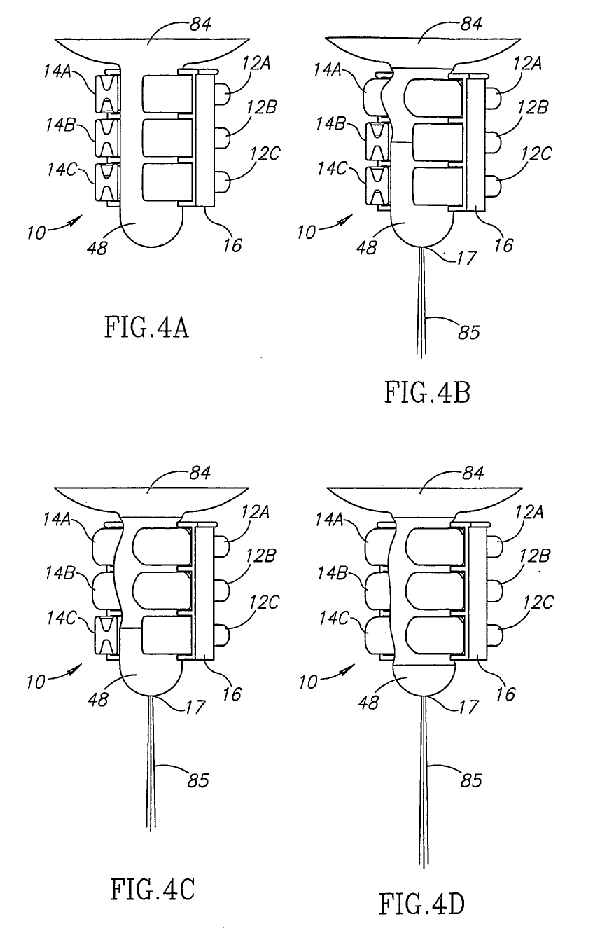

Milk collector 48 is capable of being compressed by gripper apparatus 10 when the latter is operational as described below in conjunction with FIGS. 3A-4D. When operational, gripper apparatus 10 squeezes the teat of the ruminant positioned in milk collector 48. For clarity, the right gripper apparatus 10 in FIGS. 2A-2B are shown in cut away view. Gripper apparatus 10 includes a housing 16 which further includes several constricting elements 14A-14C. The number of such elements in FIGS. 2A-2B is three but that number is exemplary only and not intended to be limiting.

Constricting elements 14A-14C are typically sack-like elements periodically filled with, and then emptied of, air provided by a pneumatic source 58. A controller 56 is in communication with and controls three pneumatic valves, typically solenoid valves 60, only one of which is shown in FIG. 2A. Each solenoid valve 60 is in communication with a different one of the three constricting sack-like elements 14A-14C by delivery tubes 12A-12C respectively. Solenoid valves 60, in communication with pneumatic source 58, periodically open and close allowing the filling of sack-like elements 14A-14C with air.

After milk is expressed into milk collector 48 as a result of the pressure exerted on the teat by constricting elements 14A-14C, the milk is led to claw 46 via connecting tube 44. Connecting tube 44 may be integrally formed with milk collector 48. A peristaltic pump 52 then pumps the milk from milk claw 46 via connecting tube 50. The milk exits from pump 52 through tube 54 and is brought to a collection vessel (not shown). It should be noted that claw 46 has a port 47 for atmospheric venting thereby preventing the sub-atmospheric pressure produced by pump 52 from acting directly on the teats (not shown) positioned in milk collectors 48.

Reference is now made to FIGS. 3A-3C which show different schematic views of a gripper apparatus, generally identified as 10, for milking ruminants constructed according to an embodiment of the present invention. FIG. 3A is an isometric view of the apparatus, FIG. 3B is a lateral view of the apparatus shown in FIG. 3A and FIG. 3C is a top view of the apparatus shown in FIGS. 3A and 3B. All three views will be discussed together immediately hereinbelow. Gripper apparatus 10 shown in FIGS. 3A-3C is a typical apparatus usable with the system described above in conjunction with FIGS. 2A-2B.

Gripper 10 includes a generally cylindrical casing 16 in which three independent hollow expandable sacks 14A, 14B and 14C are situated, the latter acting as constricting elements. Without being limiting, sacks 14A-14C are typically constructed of flexible silicone or rubber, such as NBR or Neoprene (poychloroprene), compositions, well known to those skilled in the art. Each sack is attached to an air compressor or other pneumatic device (element 58 in FIG. 2A) which provides air cyclically to sacks 14A-14C. Cylindrical casing 16 is typically constructed of stainless steel or a mold injected plastic.

When air is provided to the sacks the filling of the sacks acts very much like the closing of a human hand around a ruminant's teat. Since the sacks have a limited outer diameter they generally expand towards the center. Each sack can be thought of as a finger on a milkers hand. The sacks 14A-14C are connected to a pneumatic device (element 58 in FIG. 2A) by corresponding delivery tubes 12A-12C only partially shown in FIGS. 3A-3C. There is a solenoid activated valve (element 60 in FIG. 2A) that determines which sack-like constricting element 14A-14C is filled by the pneumatic device at any given point in a cycle. The solenoid activated valve is controlled by a controller (element 56 in FIG. 2A) which determines which sack-like constricting element is filled or emptied and when. At the end of each cycle the air is allowed to escape from all the sack-like constricting elements and another cycle begins.

Milk squeezed by expanded sacks 14A-14C is led from the aperture of the teat duct (not shown) into milk collectors 48 (as seen in FIGS. 2A and 2B). The teat aperture is generally positioned below the lowest sack-like constricting element 14C. The expressed milk is delivered from milk collector 48 to claw 46 (shown in FIGS. 2A and 2B) and from there it is led to a collection vessel (not shown).

While FIGS. 3A-3C show three hollow sacks as discussed below, it can be readily understood by one skilled in the art that more than three, and even two, sacks can also be used.

A typical, but non-limiting, size for cylinder 16 in FIGS. 3A-3C, suitable for use when milking a cow, is one having an outer diameter of 56 mm, an inner diameter of 30 mm and a height of 62 mm.

Hollow expandable sack-like constricting elements 14A, 14B and 14C can be attached to cylinder 16 in any number of ways. As best seen in FIG. 3A, cylinder 16 may contain radially-shaped, generally horizontal, shelf-like partitions 19 on which sacks 14A, 14B and 14C can be positioned and held in place.

FIGS. 4A-4D, to which reference is now made, depict one embodiment of the method with which the gripper apparatus of a milking system, such as the one shown in FIGS. 2A-3C described above, operates. In FIGS. 4A-4D, cylinder 16 of gripper apparatus 10 has been partially cut away so that sack-like constricting elements 14A-14C can be viewed more easily. Similarly, connecting tube 44 shown in FIGS. 2A-2B is not shown in FIGS. 4A-4D so that the milk flow 85 can more easily be seen.
1. The animal's teat (not shown) is inserted inside a flexible, compressible milk collector 48 and then inside cylinder 16 of gripper apparatus 10 (FIG. 4A). The junction of the teat and udder is generally positioned at or near the top of sack-like constricting element 14A of gripper apparatus 10. At this point compressing elements 14A-14C of gripper apparatus 10 are all deflated.
2. FIG. 4B shows sack-like constricting element 14A filled with air provided by a pneumatic device (element 58 in FIG. 2A above). The air is delivered via delivery tube 12A. Filled sack-like constricting element 14A closes around the top of the teat cutting off its milk duct (not shown) from the udder 84. A flow of milk 85 begins from teat aperture 17.
3. FIG. 4C shows sack-like constricting element 14B filled with air provided by a pneumatic device (element 58 in FIG. 2A above). The air is delivered via delivery tube 12B. After filling element 14B, milk in the teat's milk duct is pushed further along in the teat and milk flow 85 becomes stronger. At this stage, sack-like element 14A is still inflated.
4. FIG. 4D shows sack-like constricting element 14C filled with air provided by a pneumatic device (element 58 in FIG. 2A above). The air is delivered via delivery tube 12C. After filling constricting element 14C, milk in the teat's milk duct is pushed yet further along and out of the teat, and the milk flow 85 becomes even stronger. Pressure on sacks 14A-14C is maintained until all the milk in the teat duct is drained.
5. The air in sack-like constricting elements 14A-14C is then emptied concurrently so that sack-like constricting elements 14A-14C return to their deflated states as shown in FIG. 4A.
6. The cycle of steps 2-5 above is repeated until the conclusion of the milking process.

In another embodiment of the method, sack-like constricting element 14A can be filled with air followed by the filling of sack-like constricting element 14B. After element 14B is filled, air is emptied from sack 14A. Then sack-like constricting element 14C is filled. After element 14C is completely filled, sack-like constricting element 14B is emptied. Finally, after the milk flow stops, sack-like constricting element 14C is emptied and sack-like constricting element 14A is again filled. This cycle is repeated until the entire milking operation is completed.

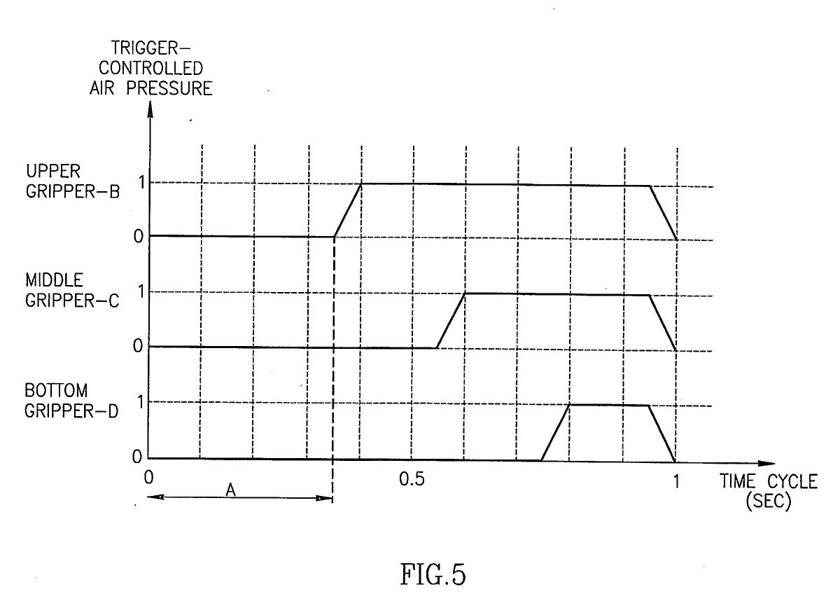

FIG. 5, to which reference is now made, shows a graphical representation of the pressure-time inflation sequence used with the apparatus and method shown in, and discussed in conjunction with, FIGS. 3A-3C and FIGS. 4A-4D, respectively. It should readily be understood that while the time axis shows a cycle having a duration of one second, the cycle can be longer or shorter. Typically, but without being limiting, it is shorter than one second.

The portion of the x-axis denoted as A represents that part of the cycle wherein all the sack-like constricting elements of the gripper are deflated. Graph B shows the cycle from the vantage point of first sack-like constricting element 14A of gripper 10 in FIGS. 3A-3C and 4A-4D. At approximately 0.35 seconds of the cycle a solenoid activated valve allows air from a pneumatic source into sack-like constricting element 14A. Constricting element 14A remains inflated until approximately 0.95 seconds into the cycle. As shown in graph C, sack-like constricting element 14B of gripper 10 is inflated at approximately 0.55 seconds of the cycle and it remains inflated until about 0.95 seconds into the cycle. Finally, as shown in graph D, sack-like constricting element 14C of gripper 10 is inflated at approximately 0.75 seconds of the cycle and remains inflated until approximately 0.95 seconds into the cycle, when it and sack-like constricting elements 14A and 14B are deflated. Again, the general outline of the cycle in FIG. 5 remains valid for cycles of any duration; the one second cycle of FIG. 5 shown in FIGS. 4A-4D is meant to be non-limiting and exemplary only. Similarly, the point of inflation for each of the sack-like constricting elements is only exemplary. For example, inflation of element 14A in graph B can be earlier or later than 0.35 seconds into the cycle and deflation can occur earlier or later than 0.95 seconds into the cycle.

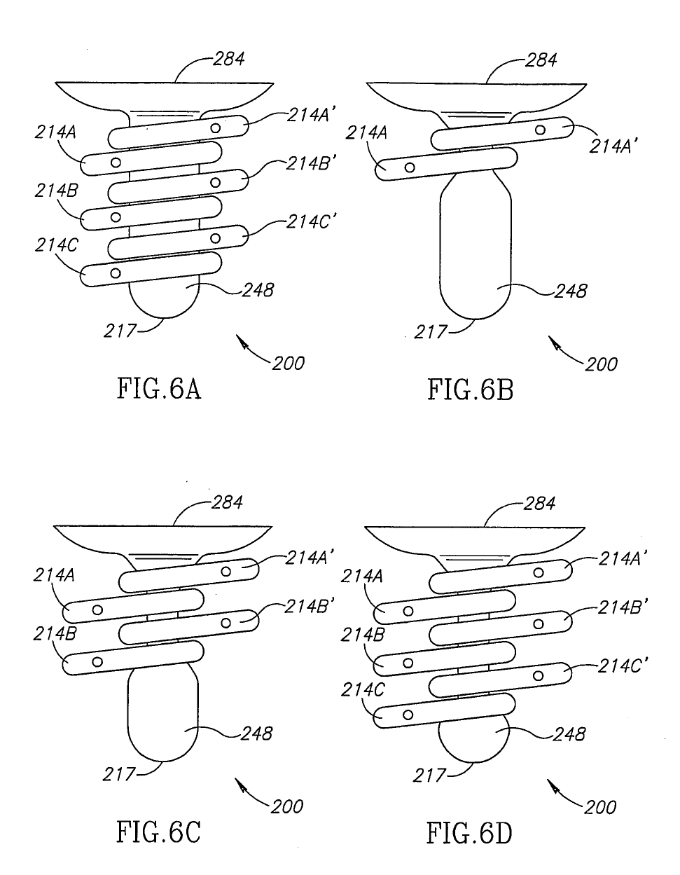

Reference is now made to FIGS. 6A-6D where another embodiment of the present invention is shown. The gripper apparatus, generally numbered 200, is made up of pairs of displaceable rings, each pair forming a constricting ring element. The rings are typically constructed of reinforced plastic or stainless steel and their diameter is sufficient to allow the free insertion of a ruminant's teat within the rings.

As shown in FIG. 6A, each of the rings of constricting ring elements 214A-214A′, 214B-214B′ and 214C-214C′ is placed asymmetrically, that is they are offset, around milk collector 248 into which a teat (not visible) of a ruminant is inserted. One ring, for example ring 214A, of each pair is asymmetrically positioned towards the left (when viewing the Figure) while the complementary second ring, for example ring 214A′, is asymmetrically positioned towards the right (when viewing the Figure).

As is shown in FIG. 6B, when the pair of rings in constricting ring element 214A-214A′ is activated, i.e. brought into their constricting mode, each ring in the element is displaced further in its offset direction producing an even greater eccentricity. These asymmetric displacements generate a constriction easily visible in FIG. 6B. As in the case of the first embodiment discussed in conjunction with FIGS. 3A-4D where inflatable sack-like constricting elements are used, the first constricting ring element 214A-214A′ is positioned as close to the teat-udder junction as possible, thereby preventing milk from flowing from the udder to the teat and vice-versa during the constriction stages (FIGS. 6B-6D) of the milking cycle.

For clarity, only complementary constricting ring element 214A-214A′ is shown in FIG. 6B. However, it should be remembered that, as shown in FIG. 6A, two other pairs of constricting ring elements 214B-214B′ and 214C-214C′ are also disposed along the length of the teat in a direction away from the udder. Each of the rings in these constricting ring elements is offset, i.e. disposed asymmetrically, along the long axis of the teat, from its complementary ring as described above with respect to ring pair 214A-214A′.

The complementary ring pairs of the constricting ring elements are activated sequentially beginning with the pair 214A-214A′ nearest the teat-udder junction and then proceeding from complementary pair to complementary pair in the direction away from the udder toward teat aperture 217. This sequential activation is illustrated in FIGS. 6B-6D to which reference is now made. For clarity, FIG. 6B shows the rings of only one constricting ring element 214A-214A′ in their activated constricting positions. Similarly, FIGS. 6C and 6D show two and three constricting ring elements respectively in their constricting positions (modes). Each displaced pair pushes the milk in the teat further away from udder 284 and out of teat aperture 217. After all the constricting ring elements have been displaced, the pair of rings in each constricting ring element return to their original asymmetric (offset) positions, as shown in FIG. 6A. The teat then refills with milk received from the udder, and the process shown in FIGS. 6B-6D is repeated.

Each pair of rings in a constricting ring element surrounds the teat which is itself encased in a compressible milk collector 248 constructed of rubber or other compressible material. The milk collector 248 receives the milk as it is squeezed out of the teat and conveys it via a tube (not shown) to a milk claw (not shown) and from there to a collection vessel (not shown) in a manner analogous to that shown in and discussed in conjunction with FIGS. 2A and 2B.

The constricting ring elements of FIGS. 6A-6D are typically contained in a housing (not shown). They are activated by a mechanical displacing means, typically a cam driven system, readily constructible by one skilled in the art. The cam driven system selectably switches the constricting ring elements from their non-constricting to constricting mode and vice-versa.

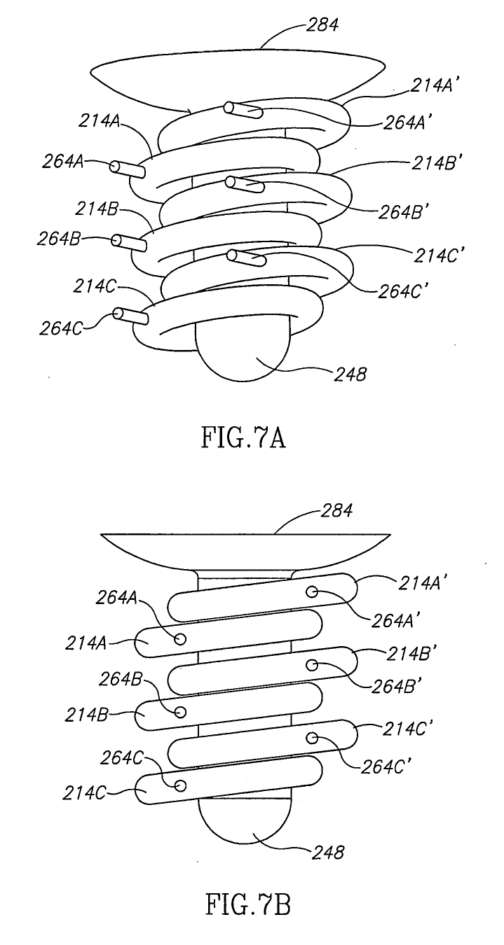

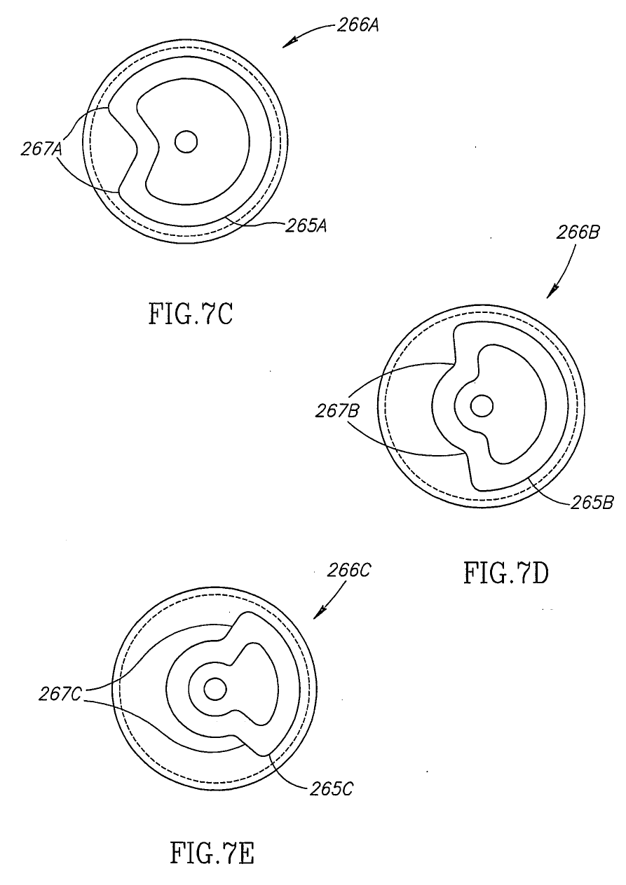

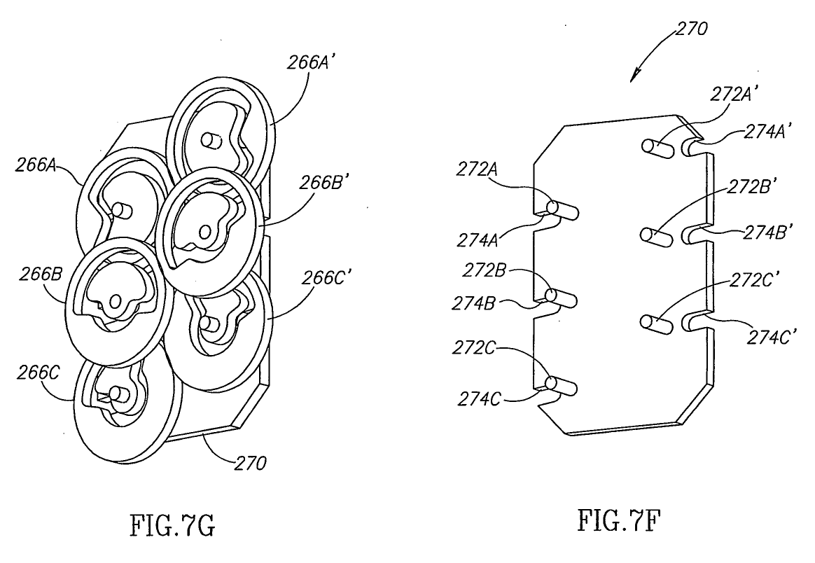

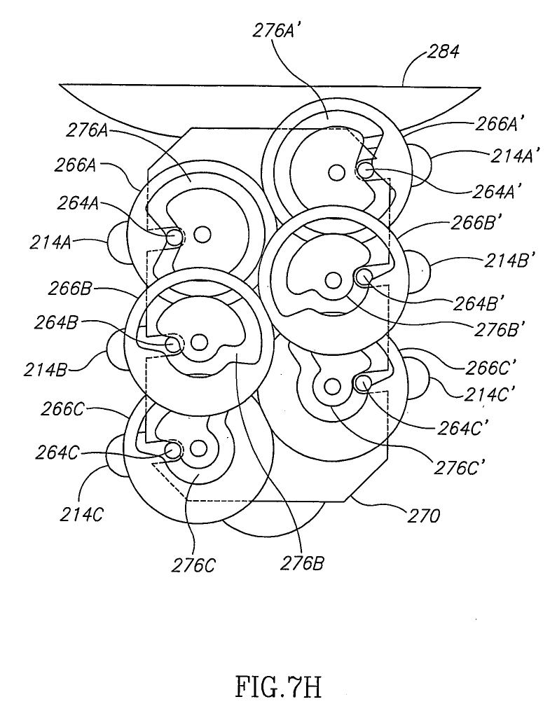

A typical mechanical displacing means based on a cam driven mechanism is shown in FIGS. 7A-7H to which reference is now made. FIGS. 7A and 7B show two views of the constricting ring elements discussed above in conjunction with FIGS. 6A-6D. In addition to what is described therein, each ring contains a pin. In the case of rings 214A and 214A′ the pins are denoted 264A and 264A′ respectively. Similarly, rings 214B, 214B′ 214C and 214C′ include pins 264B, 264B′, 264C and 264C′ respectively. A typical but non-limiting diameter for the pin may be 3 mm. These pins assist in transferring the forces which displace their respective constricting ring elements as will be discussed below.

FIGS. 7C-7E show three cams 266A-266C for use with constricting ring elements 214A-214A′, 214B-214B′ and 214C-214C′ respectively. Cams 266A-266C each have different dwell sectors 267A-267C and active sectors 265A-265C. The size of the active and dwell sectors of each cam is related to the amount of time that each constricting element is required to be in its displaced position, i.e. constricting mode, such as is shown in FIGS. 6B-6D. In cam 266A there is a larger active sector 265A than a dwell sector 267A; in cam 266B the active 265B and dwell 267B sectors are about the same size; in cam 266C the active sector 265C is smaller than the dwell sector 267C.

Reference is now made to FIGS. 7F and 7G. Six cams 266A-266C and 266A′-266C′ are positioned on pins 272A-272C and 272A′-272C′ respectively, these latter pins integrally formed on carrier board 270 shown in FIG. 7F. FIG. 7F also shows notches 274A-274C and 274A′-274C′ into which pins 264A-264C and 264A′-264C′ fit, the latter discussed above in conjunction with FIGS. 7A-7B. FIG. 7G shows the six cams 266A-266C and 266A′-266C′ after being positioned on carrier board 270. As noted above, each pair of cams 266A-266A′, 266B-266B′ and 266C-266C′ have different active and dwell sectors, but the active and dwell sectors are identical for the two cams in a single pair.

FIG. 7H shows a view of the cam carrier board 270 mounted to the constricting ring elements 214A-214C and 214A′-214C′. Pins 264A-264C and 264A′-264C′ (best seen in FIGS. 7A-7B) of the six rings of the three constricting ring elements are inserted into curved grooves 276A-276C and 276A′-276C′ respectively. The synchronized travel of pins 264A-264C and 264A′-264C′ around grooves 276A-276C and 276A′-276C′ of cams 266A-266C and 266A′-266C′ produces the timed displacements and resulting teat compression and constriction described above in FIGS. 6A-6D.

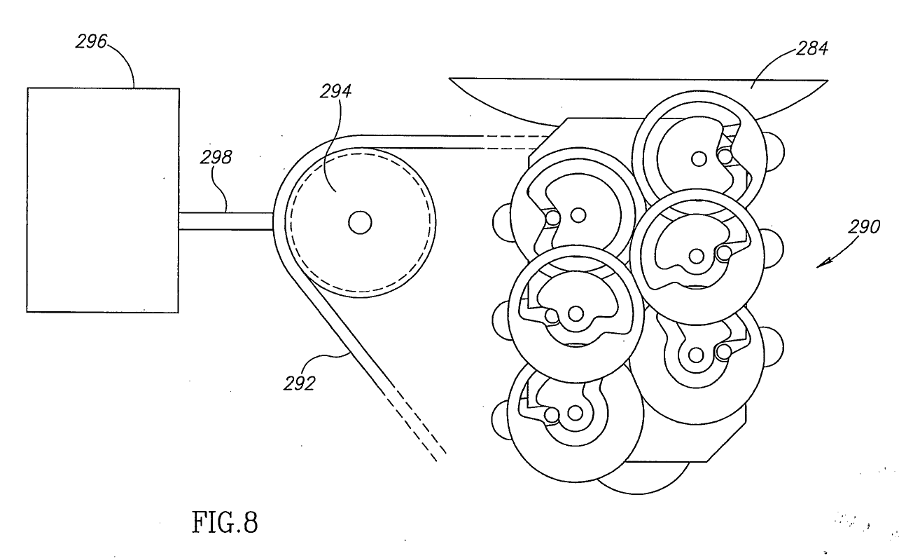

FIG. 8, to which reference is now made, shows a controller 296 in electrical communication 298 with a motor and gear drive, both referenced 294. Through timing belt 292, motor and gear drive 294 sets cam mechanism, generally referenced as 290, in motion. Cam mechanism 290 is discussed in detail above in conjunction with FIGS. 7A-7H and therefore will not be discussed here. The controller inter alia controls starting and stopping the motor, a motor voltage supply (not shown), and varies the speed of the cam mechanism, thereby controlling the temporal and spatial displacement requirements of the constricting ring elements shown in FIGS. 6A-6D. The integration of the controller with the embodiment described in conjunction with FIGS. 6A-7H can readily be effected by one skilled in the art.

Systems which include a gripper apparatus as described in any of the above embodiments have the following advantages over conventional vacuum-assisted milking systems:
1. They do not produce bleeding in the teat and inflammation and infection of the teat as do vacuum-assisted systems.
2. The teat's sphincter is not weakened as it is with vacuum-assisted systems.
3. Milk cannot return to the udder causing contamination as may occur with a vacuum-assisted system.
4. Since the base of the teat is closed off from the udder during milking, milk cannot return to the udder, thereby reducing or eliminating pain to the animal.
5. Cost of the system is less than a vacuum-assisted system. Large vacuum machines are not required in the present invention.
6. The present gripper apparatus, system and method generates a faster milking rate producing more milk than does conventional vacuum-assisted milking systems. A cow milked using a vacuum system having four teat cups typically generates 10-15 liters of milk in six minutes or approximately 0.4-0.6 liter per cup per minute. A system using the gripper apparatus of the present invention is expected to draw approximately 15-60 cc per gripper cycle. Using a relatively long cycle of one second, at least 900 cc per cup per minute would be drawn and milking would be completed in approximately four minutes.

It will be appreciated by persons skilled in the art that the present invention is not limited by what has been particularly shown and described herein above. Rather the scope of the invention is defined by the claims that follow:

1. An apparatus for gripping the teat of an animal and assisting in drawing milk from the animal via a compressible milk collector, said apparatus including:
a housing;
a plurality of constricting elements arranged in said housing in touching relation to the milk collector, said constricting elements being selectably operable in constricting and non-constricting modes;
means for selectably switching said constricting elements back and forth between non-constricting and constricting modes; and
a controller in communication with said means for selectably switching, said controller operative to effect a predetermined timing and sequence for periodically switching said constricting elements between their constricting and non-constricting modes, thereby to compress the teat of the animal drawing milk therefrom.

2. An apparatus according to claim 1, wherein said constricting elements are pneumatically inflatable sack-like elements.

3. An apparatus according to claim 2, wherein said means for selectably switching is a pneumatic means.

4. An apparatus according to claim 3, wherein said pneumatic means includes an air compressor and pneumatic air valves, said valves operated by said controller.

5. An apparatus according to claim 1 wherein said constricting elements are pairs of complementary displaceable rings.

6. An apparatus according to claim 5, wherein said means for selectably switching is a cam-based mechanical switching system.

7. An apparatus according to claim 5, wherein said pairs of complementary displaceable rings each include a first and second ring, each said ring being asymmetrically positioned around a teat inserted into a milk collector, and when activated said second ring of said pair of complementary rings is displaced in a direction opposite to the direction of displacement of said first ring of the pair, thereby compressing the teat.

8. An apparatus according to claim 1 wherein said housing is cylindrically-shaped.

9. A system for milking an animal, said system including:
at least one apparatus for gripping the teat of an animal and assisting in drawing milk from the animal via a compressible milk collector, said apparatus including:
a housing;
a plurality of constricting elements arranged in said housing in touching relation to the milk collector, said constricting elements being selectably operable in constricting and non-constricting modes;
means for selectably switching said constricting elements, back and forth between the non-constricting and constricting modes; and
a controller in communication with said means for selectably switching, said controller operative to effect a predetermined timing and sequence for periodically switching said constricting elements between the constricting and non-constricting modes; and
a milking claw in flow communication with the milk collector and which collects milk accumulated within the milk collector, said claw having a vent to maintain atmospheric pressure on the teat;
a suction generating means that draws milk from said claw; and
a collection vessel in flow communication with said suction generating means in which milk drawn from said milking cow is collected.

10. A system according to claim 9, wherein said constricting elements are pneumatically inflatable sack-like elements.

11. A system according to claim 10, wherein said means for selectably switching is a pneumatic means.

12. A system according to claim 11, wherein said pneumatic means includes an air compressor and pneumatic air valves, said valves operated by said controller.

13. A system according to claim 9, wherein said constricting elements are pairs of complementary displaceable rings.

14. A system according to claim 13, wherein said means for selectably switching is a cam-based mechanical switching system.

15. A system according to claim 13, wherein said pairs of complementary displaceable rings each include a first and second ring, each said ring being asymmetrically positioned around a teat inserted into a milk collector, and when activated said second ring of said pair of complementary rings is displaced in a direction opposite to the direction of displacement of said first ring of the pair, thereby compressing the teat.

16. A system according to claim 9, wherein said housing is cylindrically-shaped.

17. A method for milking an animal, wherein said method includes the steps of:
positioning a teat of the animal in a compressible milk collector;
constricting the teat at a point near the udder-teat junction of the animal;
constricting the remainder of the teat in a predetermined temporal and spatial sequence;
releasing the constricted teat after all milk in the teat has been expressed therefrom, thereby allowing the teat to return to its unconstricted state, the expressed milk flowing into the milk collector; and
repeating the steps of constricting and releasing until termination of the milking operation.

18. A method according to claim 17 wherein said step of constricting the remainder of the teat includes constricting individual sections of the teat in a predetermined sequence in a direction away from the udder, the individual sections being held constricted until all sections of the teat have been constricted.

19. A method according to claim 18, wherein said predetermined sequence of constricting individual sections is a linear sequence wherein each section is constricted after its immediately preceding section.

20. A method according to claim 18, wherein said step of releasing includes releasing all sections of the constricted teat simultaneously.

21. A method according to claim 17, wherein said step of constricting the remainder of the teat includes constricting individual sections of the teat in a predetermined sequence in a direction away from the udder, each individual section being held constricted only until the next section is constricted, the next section being the adjacent section further away from the udder.

22. A method according to claim 21, wherein said step of releasing includes releasing a constricted section of the teat after the next adjacent section of the teat in a direction away from the udder has been constricted.

23. A method according to claim 22, wherein said step of releasing further includes releasing the constricted section of the teat furthest from the udder after substantially all the milk in the teat has been expressed.

24. A method for milking, wherein said method includes the steps of:
positioning a teat of an animal in a compressible milk collector and further positioning the teat and milk collector within a gripper apparatus;
activating a portion of the gripper apparatus so that the section of the teat nearest the udder-teat junction of the animal is constricted;
activating the remaining portions of the gripper apparatus so that the remaining sections of the teat are constricted in a predetermined temporal and spatial sequence beginning at the portion of the teat closest to the udder and proceeding to the portion of the teat furthest from the udder;
releasing the constricted teat after all the milk in the teat has been expressed therefrom, thereby allowing the teat to return to its non-constricted state, the expressed milk flowing into the milk collector; and
repeating said steps of activating and releasing until termination of the milking operation.

25. A method according to claim 24, wherein the gripper apparatus includes constricting elements which are individually and in a predetermined sequence brought into their constricting mode from their non-constricting mode while proceeding in a direction away from the udder of the animal.

26. A method according to claim 25, wherein said step of releasing includes releasing all of the constricting elements of the gripper apparatus simultaneously after all the elements have been activated, thereby returning them all to their non-constricting mode from their constricting mode.

27. A method according to claim 25, wherein said step of positioning includes the step of positioning the junction of the teat and udder near a first constricting element, where such first constricting element is the element closest to the animal's udder.

28. A method according to claim 24, wherein the gripper apparatus includes constricting elements which are individually and in a predetermined sequence brought into their constricting mode from their non-constricting mode while proceeding in a direction away from the udder of the animal, each constricting element being activated after the activation of its preceding adjacent constricting element in the direction toward the udder, while all other preceding constricting elements have been returned to their non-constricting mode.

29. A method according to claim 28, wherein said step of positioning includes the step of positioning the junction of the teat and udder near a first constricting element, where such first constricting element is the element closest to the animal's udder.

30. An apparatus for gripping the teat of an animal and assisting in drawing milk from the animal via a compressible milk collector, said apparatus including:
a housing;
a plurality of constricting elements arranged in said housing in touching relation to the milk collector, said constricting elements being selectably operable in constricting and non-constricting modes; and
means for selectably switching said constricting elements, back and forth between said non-constricting and constricting modes, thereby to compress the teat of the animal drawing milk therefrom.

31. An apparatus according to claim 30, wherein said constricting elements are pneumatically inflatable sack-like elements

32. An apparatus according to claim 31, wherein said means for selectably switching is a pneumatic means.

33. An apparatus according to claim 32, wherein said pneumatic means includes an air compressor and pneumatic air valves.

34. An apparatus according to claim 30, wherein said constricting elements are pairs of complementary displaceable rings

35. An apparatus according to claim 34, wherein said means for selectably switching is a cam-based mechanical switching system.

36. An apparatus according to claim 35, wherein said pairs of complementary displaceable rings each include a first and second ring, each said ring being asymmetrically positioned around a teat inserted into a milk collector, and when activated said second ring of a pair of complementary rings is displaced in a direction opposite to the direction of displacement of said first ring of the pair, thereby compressing the teat.
